(19) United States
(12) Patent Application Publication
(10) Pub. No.: US 2025/0298447 A1
(43) Pub. Date: Sep. 25, 2025

(54) PROACTIVE TEMPERATURE AND FAN SPEED BASED APPLICATION ECO-QOS TRIGGERING

(71) Applicant: DELL PRODUCTS L.P., Round Rock, TX (US)

(72) Inventors: Suraj M. Varma, Portland, OR (US); Farzad Khosrowpour, Pflugerville, TX (US); Travis North, Cedar Park, TX (US)

(21) Appl. No.: 18/609,189

(22) Filed: Mar. 19, 2024

(51) Int. Cl. G06F 1/20

(52) U.S. Cl. CPC G06F 1/206

(57) ABSTRACT

An information handling system includes a memory device configured to store code, and a processor configured to execute code. The processor receives environmental information for the information handling system, and sets an application instantiated on the information handling system to an EcoQoS level based on the environmental information.

### FIELD OF THE DISCLOSURE

This disclosure generally relates to information handling systems, and more particularly relates to proactively triggering application eco-quality of service levels based on component temperatures and fan speeds in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may receive environmental information, and set an application instantiated on the information handling system to an eco-quality of service level based on the environmental information.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a block diagram illustrating an information handling system according to another embodiment of the present disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

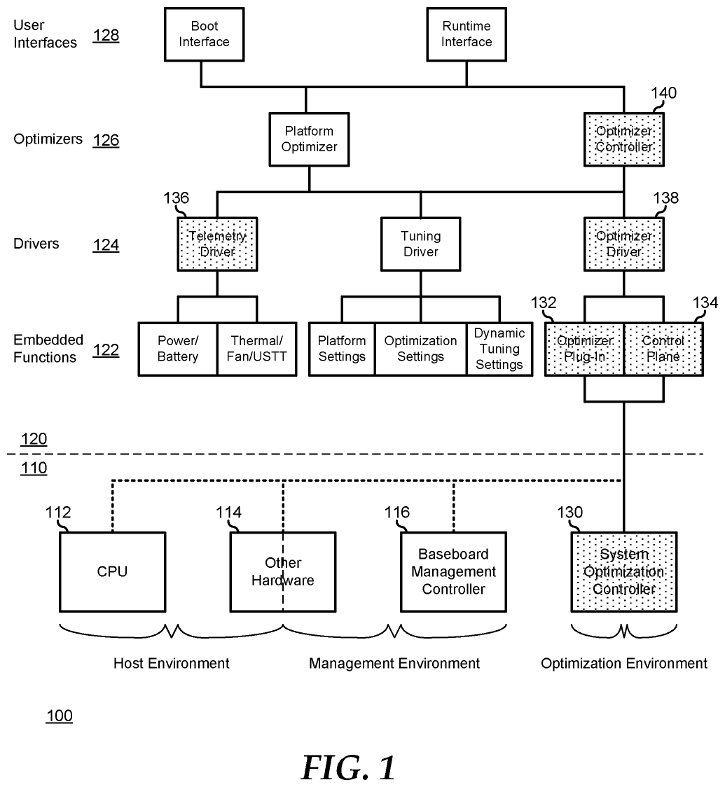

FIG. 1 illustrates an information handling system 100 including system hardware 110 and system code 120. System hardware 110 represents hardware devices that are provided on information handling system 100 to implement a host environment, a management environment, and an optimization environment. In a particular embodiment, the host, management, and optimization environments represent separate processing systems to implement the functions and features of the associated environment. In particular, the host environment includes one or more processors (CPU) 112, and other hardware 114 that implement the functions and features normally associated with the processing tasks to which information handing system 100 is dedicated. In particular, the host environment may function to instantiate a Basic Input/Output System/Universal Extensible Firmware Interface (BIOS/UEFI) that loads an operating system (OS) to provide a processing environment to launch programs, applications, utilities, or the like. As such, other hardware 114 may include various I/O controller hubs, system memory devices, non-volatile memory devices, storage devices, human interface devices, network interface devices, or the like, as needed or desired. The functions and features of a host environment, including the instantiation of a BIOS/UEFI on hardware devices, the loading of an (OS), and the launching of programs, applications, and utilities, is known in the art and will not be further described herein, except as may be needed to illustrate the current embodiments.

The management environment includes a baseboard management controller (BMC) 116 and other hardware 114 that implement functions and features to monitor, manage, and maintain the operating state of information handling system 100 out-of-band from the operation of the host environment. To this end, BMC 116 is illustrated as being connected to CPU 112 and to other hardware 114. Some portions of other hardware 114 may be provided to implement the management environment, such as dedicated memory devices, complex programmable logic devices (CPLDs), lifecycle controllers, trusted platform modules, and the like. Further, other portions of other hardware 114 may represent the processing devices within the host environment itself. In this case, BMC 116 may be connected to various management interfaces of the hardware devices, such as via Inter-Integrated Circuit (I2C) or Improved Inter-Integrated Circuit (I3C) interfaces, System Peripheral Interfaces (SPIs), or the like, to obtain management information from the connected devices. Still other portions of other hardware 114 may represent auxiliary devices for operating information handling system 100, such as system cooling fans, system power supplies and voltage regulators, and the like.

In monitoring the operating state of information handling system 100, BMC 116 operates to access information from CPU 112, other hardware 114, and various elements of system code 120 to determine the operating state of the various elements, and to report the operating state information to a user or system administrator of the information handling system, or to a management system associated with the information handling system. In managing the operating state of information handling system 100, BMC 116 operates to set, adjust, change, or otherwise manipulate the settings, configurations, operating modes, or the like, of the various elements of hardware and software. For example, BMC 116 can set hardware parameters, BIOS/UEFI settings, firmware settings, safety and security settings, or the like, as needed or desired. In maintaining the operating state of information handling system 100, BMC 116 operates to provide for out-of-band firmware updates, reinstalls, reimages, and the like. For example, BMC 116 may operate to download and store BIOS/UEFI images or other firmware images out-of-band from the host environment, such that, on a next reboot of information handling system 100, the updated images are installed into the information handling system.

System software 120 includes embedded functions 122, drivers 124, optimizers 126, and user interfaces 128. Embedded functions 122 represent firmware associated with various hardware devices and functional settings for information handling system 100. Examples of embedded functions may include firmware provided to monitor, manage, and maintain power supplies, batteries, voltage regulators, and the like, thermal settings and system cooling devices as may be configured by an optimizer driver, platform settings such as BIOS/UEFI settings or firmware ROM settings, optimization settings, dynamic tuning settings as may be configured by a tuning driver, or other embedded functions, as needed or desired. or the like.

In addition to the monitoring, management, and of information handling systems as described above, information handling systems are increasingly being evaluated to ensure that the performance of not just the information handling systems, but also of the networks of which the information handling systems form a part, are optimized to provide the peak processing experience of the users of the information handling systems, peak performance of the networks, most efficient operation of both the information handling systems and the networks, and the like. For example, a typical information handling system deployed in an edge network may be configured to execute some processing tasks locally, while other tasks are performed in the edge network. The balance of processing tasks between the information handling system and the edge network is constantly being evaluated to ensure that a particular policy or performance goal is being achieved. To this end, the manufacturers of information handling systems are increasingly deploying functional code on their information handling systems that operate to provide various performance optimizations. Such functional code provides the manufacturers with the ability to distinguish their products from their competitors and to provide added value to their customers.

The functional code may be provided by more than one manufacturer on a particular information handling system. For example, an information handling system may include an OS image, such as a Windows OS, a Linux OS, or the like, an Intel Dynamic Tuning Technology suite (such as a driver, firmware associated with various Intel devices on the information handling system, or the like), a manufacturer optimization suite (such as a Dell Optimizer suite including an optimizer plug-in, a control panel, a driver, an optimizer controller, or the like), and various other device optimizers provided by the manufacturers of the various devices. A device manufacturer may provide the device in accordance with a particular governing specification, but may also include various custom features that enhance the operations of the device, and that are accessible only through their own driver or optimizer. Thus the availability of a particular optimization or enhancement may be predicated on both the presence of the particular device and the associated device firmware or firmware revision to unlock the capability of the device.

It has been understood by the inventors of the current disclosure that a typical software image, such as an OS update, or a BIOS/UEFI update is propagated by the vendor of the particular software, and as such, does not always include the optimizations and enhancements associated with other vendor's products. Because of this, the value-added features associated with these products get deleted and disabled as the new software images are installed. Further, in order to retain such value-add features, a user or system administrator must typically take separate steps to install the various software packages on top of the software image. This problem is further exacerbated by the number of different add-on software packages that may need to be separately installed. As a result, the inventors have understood that many users or system administrators therefore do not bother to retain these software packages out of convenience.

The optimization environment represents a separate operating environment that operates out-of-band from the host environment, and includes a system optimization controller (SOC) 130, an optimizer plug-in 132 and a control plane 134 within embedded functions 122, a telemetry driver 136 and an optimizer driver 138 within drivers 124, and an optimizer controller 140 within optimizers 126. In a particular embodiment, the optimization environment, and particularly SOC 130 represents a separate processing device from BMC 116. In particular, the optimization environment may operate out-of-band from both the host environment and the management environment, as needed or desired. In another embodiment, SOC 130 represents an expanded functionality of BMC 116. In either case, SOC 130 represents a processing capacity that is tailored to the optimization of the functions and features of information handling system 100, both as a stand-alone system, and as a part of a network such as an edge network. As such, SOC 130 may be understood to include additional hardware elements, such as non-volatile memory devices, compute devices, I/O devices, or the like.

The optimization environment operates to monitor the operations of the hardware and software elements of information handling system 100. As such, SOC 130 is illustrated as being connected to CPU 112, other hardware 114, and BMC 116. The connections can include the management interfaces as described above, or other dedicated interfaces, as needed or desired. SOC 130 is further connected to optimizer plug-in 132 and control plane 134, and through the optimizer plug-in and the control plane to optimizer driver 138. As illustrated, optimizer driver 138 is in communication with telemetry driver 136 and a tuning driver to reach down to the various functions of embedded functions 122. As illustrated, the optimization environment can work in parallel with various platform optimizers via optimizer controller 140, or, in the absence of such platform optimizers, the optimizer controller can operate alone to provide managed optimizations for information handling system 100. For example, optimizer controller 140 can receive various policy directives from a boot interface or a runtime interface in user interfaces 128 to control the optimization scheme deployed by the optimization environment. The boot interface represents, for example, a BIOS setup interface, while the runtime interface represents for example, a user interface that permits the user or system administrator to set or alter the optimization scheme, as needed or desired. In a particular embodiment, SOC 130 utilizes various machine learning (ML) algorithms, as described further below, to optimize the operating state of information handling system 100 and the network of which the information handling system is a part.

The optimization environment further operates to maintain the optimization state of information handling system 100. In particular, SOC 130 maintains stored copies of the various optimization firmware deployed on information handling system 100. Then, when an image restoration or reimaging of information handling system 100 is performed, SOC 130 operates to check the image for the presence of the various optimization firmware elements. In a particular embodiment, SOC 130 operates to check the image for the various optimization firmware elements, and appends any missing firmware elements to the image prior to the installation of the new image. In another embodiment, SOC 130 operates to permit the installation of the new image, and then checks the various hardware devices and embedded functions to ensure that all firmware elements are installed. Then, any missing firmware elements are installed on top of the reinstalled image.

The optimization state of information handling system 100 may be independent of the particular architecture utilized in the information handling system. For example, information handling system 100 may include a CPU 112 and other hardware 114 that utilizes an Intel X86 architecture, an AMD X86 architecture, an ARM architecture, or another architecture, as needed or desired. SOC 130 may be configured to implement an optimization environment that is common across all architectures. That is, the internal code for SOC 130 may not need to be altered or modified to accommodate the different architectures, but may execute common code in providing the optimization environment for all architectures. In particular, various elements of embedded functions 122 may change based upon the chosen architecture. However, because SOC 130 interacts with embedded functions 122 via drivers 124, the drivers will implement any function calls as needed by the elements of the embedded functions, but the SOC can operate to provide common function calls to the drivers regardless of the chosen architecture. In this way, SOC 130 operates to abstract a baseline optimization environment for information handling system 100 form the particular architecture utilized by the information handling system.

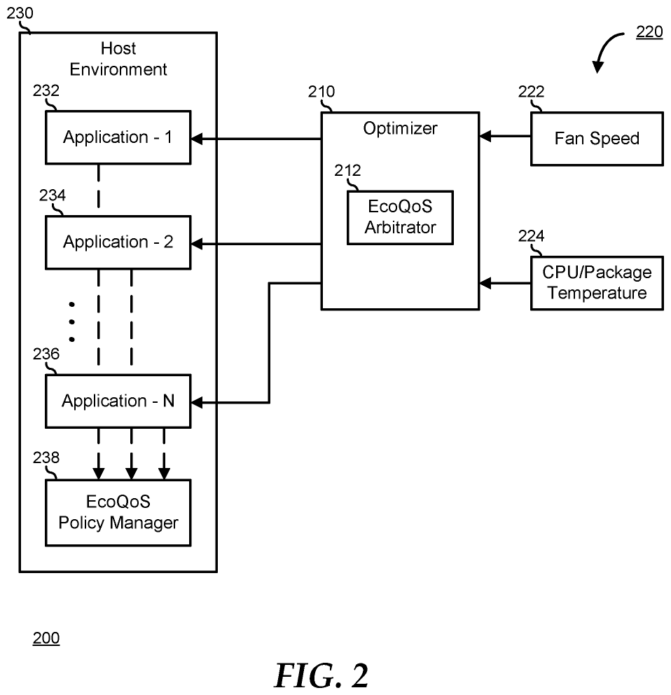

FIG. 2 illustrates an information handling system 200 similar to information handling system 100. In particular, information handling system 200 includes an optimizer 210 similar to SOC 130, inputs 220 to the optimizer, and a host environment 230. Optimizer 210 includes an Eco-Quality-of-Service (EcoQoS) arbitrator 212. Inputs 220 include a fan speed input 220 and a temperature input 222. Host environment 230 includes an application 232, an application 234, one or more additional applications 236, and an EcoQoS policy service 228.

EcoQOS is an initiative provided within various host environments, such as host environment 230, that provides an application programming interface (API) that permits application developers to ascribe an EcoQoS level to processes and threads that are running on the processors of information handling system 200. Applications 232, 234, or 236 that are ascribed the EcoQOS level are then scheduled by EcoQoS policy manager 238 to be executed on the hardware of information handling system 200 in an energy efficient manner, as described further below. In this way, developers can adjust the power consumption attributable to applications 232, 234, and 236 to optimize for lower power operations of the selected applications. For example, one or more of applications 232, 234, and 236 can be ascribed the EcoQoS level, and EcoQoS policy manager 238 operates to ensure thar such applications are executed in a low-power mode, such as by limiting the number of processes or threads launched by the applications, proscribing the core-type (such as performance cores or “p-cores,” or low-power cores or “e-cores”) utilized by the applications, limiting network or storage bandwidths, or the like.

An example of an EcoQOS initiative may include a Microsoft EcoQOS framework that operates in conjunction with various hardware device manufacturers, such as processor or system-on-a-chip (SOC) manufacturers, add-in card manufacturers, or the like, where the manufacturers provide hardware functionality that can be called by the EcoQoS framework to provide more energy efficient operation of applications 232, 234, and 236, as needed or desired. The Microsoft EcoQOS is a QoS level that can be ascribed to processes and threads which indicates that the processes and threads can be operated to balance power efficiency over processing performance. In particular, ascribing a process or thread with the EcoQOS level provides an indication to various versions of the Windows OS (i.e., to EcoQoS policy manager 238) to automatically schedule such processes or threads to run on the most efficient processors or cores, and to configure the processors or cores to operate at their most efficient clock speeds. In a first case, workloads that do not have a significant performance or latency requirement may be ascribed the EcoQOS level. Examples of such workloads may include background services, updaters, sync engines, indexing services, and the like. A software developer can ascribe the EcoQoS level to a process with a “SetProcesInformation” command in an associated API, and can ascribe the EcoQOS level to a thread with a “SetThreadInformation” command in the API.

It has been understood by the inventors of the current disclosure that more newly developed applications can be configured to take advantage of the latest EcoQOS features and the associated hardware optimizations to make for highly energy efficient and customizable operating states for the applications and the information handling system. For example, a software developer can ascribe the EcoQoS level to a particular program or application in order to provide more environmentally friendly system operation, higher battery performance operation, lower fan noise operation, lower temperature operation, or the like. However, IT managers and decision makers are understood to often be reluctant to keep up with the latest hardware and software, preferring the stability of known technologies. Further, the sunk cost of the existing technologies provides a barrier to upgrading installed systems. Finally, users within an IT environment are typically reluctant to change to new technologies, preferring to continue to use the known, legacy products. It has been further understood that the legacy software does not typically take advantage of the latest EcoQOS features and the associated hardware optimizations. In particular, the EcoQoS level is not typically ascribed to the legacy software on an information handling system.

In a particular embodiment, optimizer 210 operates to detect various environmental conditions on information handling system 200 and to dynamically ascribe the EcoQOS level to selected ones of applications 232, 234, and 236. In particular, optimizer 210 receives information regarding the current fan speed from fan speed input 222 and temperature information from temperature input 224. In particular, it will be understood that when fan speed input 222 indicates that one or more cooling fans within information handling system 200 are operating at a low speed, optimizer 210 may infer that the information handling system is operating more efficiently than when the fan speed input indicates that the cooling fans are operating at a higher speed. That is, when the fans are running slowly, it will be understood that fewer steps need to be taken to ensure that information handling system 200 is operating efficiently. Similarly, when temperature input 224 indicates that the temperature of a device, such as a processor of information handling system 200, a skin temperature of the information handling system, or the like, is low, optimizer 210 may infer that the information handling system is operating more efficiently than when the temperature input indicates that the temperature is higher. That is when the temperature is low, fewer steps need to be taken to ensure that information handling system 200 is operating efficiently.

Optimizer 210 instantiates one or more conversion tables that define a number of applications to which to ascribe the EcoQOS level based on fan speed input 222 and temperature input 224. An example of a fan speed conversion table is provided in Table 1, below, and an example of a temperature conversion table is provided in Table 2, below.

TABLE 1
Fan Speed Conversion Table

| Fan Speed (RPM) | EcoQoS Applicability | |
|---|---|---|
| 0 | 0 | Apps |
| 0-2500 | 1-2 | Apps |
| 2501-4000 | 3-5 | Apps |
| 4001-5000 | 6-10 | Apps |

| | |
|---|---|
| 5001-6000 | All Apps |

TABLE 2
Temperature Conversion Table

| Temp (C.) | EcoQoS Applicability | |
|---|---|---|
| 30-35 | 0 | Apps |
| 36-39 | 1-2 | Apps |
| 40-41 | 3-5 | Apps |
| 42-44 | 6-10 | Apps |

| | |
|---|---|
| >44 | All Apps |

Optimizer 210 operates to index the received fan speed information from fan speed input 222 into Table 1, and to index the received temperature information from temperature input 224 into Table 2. Then, based on the associated EcoQOS Applicabilities from Table 1 and Table 2, optimizer 210 operates to ascribe the EcoQoS level to the number of applications provided in the Tables. In particular, when both the Table 1 entry and the Table 2 entry define the same number of applications to which to ascribe the EcoQoS level, then optimizer 210 selects the defined number of applications, and ascribes the EcoQoS level to the selected applications. For example, when the fan speed is 4000 RPM and the temperature is 40 C, then both of Tables 1 and 2 define that 3-5 applications can be ascribed the EcoQOS level, and optimizer 210 ascribes the EcoQOS level to 3-5 applications. However, when the Table 1 entry defines a different number of applications than the Table 2 entry, then optimizer 210 provides the different entries to EcoQOS arbitrator 212 to select a number of applications for the optimizer ascribe the EcoQOS level. In a particular embodiment, EcoQoS arbitrator 212 selects a middle number between the Table 1 entry and the Table 2 entry. In another embodiment, EcoQoS arbitrator 212 provides an aggressive limiting model that selects the higher number of applications to which to ascribe the EcoQoS level. In yet another embodiment, EcoQoS arbitrator 212 provides an permissive limiting model that selects the lower number of applications to which to ascribe the EcoQoS level.

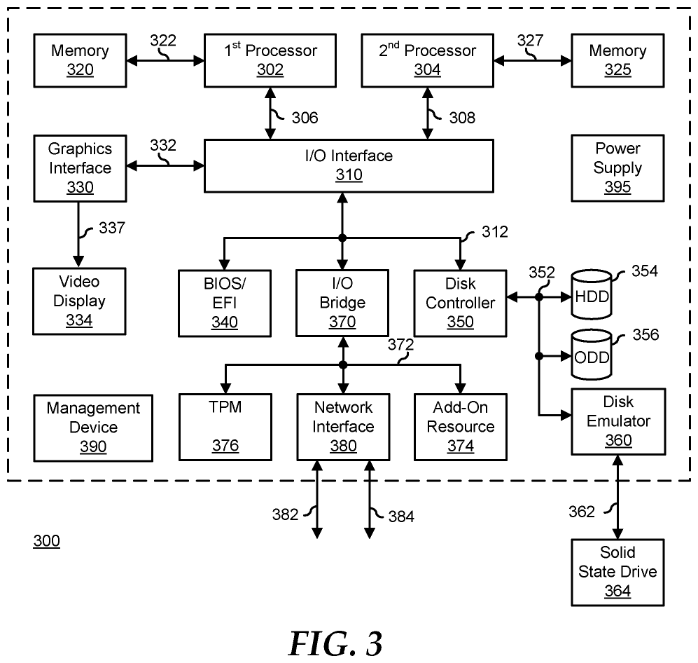

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a memory device configured to store code; and
a processor configured to execute code to:
receive first environmental information for the information handling system; and
set a first application instantiated on the information handling system to an EcoQoS level based on the first environmental information.

2. The information handling system of claim 1, wherein the processor is further configured to:
receive second environmental information for the information handling system, and
set a second application instantiated on the information handling system to the EcoQoS level based on the second environmental information.

3. The information handling system of claim 2, wherein the first environmental information indicates that the information handling system is operating at a first efficiency level and the second environmental information indicates that the information handling system is operating at a second efficiency level.

4. The information handling system of claim 2, wherein the first efficiency level is higher than the second efficiency level.

5. The information handling system of claim 1, wherein the first environmental information includes a fan speed indication.

6. The information handling system of claim 5, wherein the processor is further configured to determine a first number of applications instantiated on the information handling system to set to the EcoQOS level based on the fan speed indication.

7. The information handling system of claim 6, wherein the first environmental information further includes a device temperature indication.

8. The information handling system of claim 7, wherein the processor is further configured to determine a second number of the applications to set to the EcoQOS level based on the device temperature indication.

9. The information handling system of claim 8, wherein the processor is further configured to determine that the first number is different from the second number, and to determine a third number of the applications to set to the EcoQOS level based on the first number and the second number.

10. The information handling system of claim 9, wherein the third number is between the first number and the second number.

11. A method comprising:
receiving, by a processor of an information handling system, first environmental information for the information handling system; and
setting, by the processor, a first application instantiated on the information handling system to an EcoQoS level based on the first environmental information.

12. The method of claim 11, further comprising:
receiving second environmental information for the information handling system, and
setting a second application instantiated on the information handling system to the EcoQoS level in response to the second environmental information.

13. The method of claim 12, wherein the first environmental information indicates that the information handling system is operating at a first efficiency level and the second environmental information indicates that the information handling system is operating at a second efficiency level.

14. The method of claim 12, wherein the first efficiency level is higher than the second efficiency level.

15. The method of claim 11, wherein the first environmental information includes a fan speed indication.

16. The method of claim 15, further comprising determining a first number of applications instantiated on the information handling system to set to the EcoQoS level based on the fan speed indication.

17. The method of claim 16, wherein the first environmental information further includes a device temperature indication.

18. The method of claim 17, further comprising determining a second number of the applications to set to the EcoQoS level based on the device temperature indication.

19. The method of claim 18, further comprising:
determining that the first number is different from the second number; and
determining a third number of the applications to set to the EcoQOS level based on the first number and the second number.

20. An information handling system, comprising:
a memory device configured to store code; and
a processor configured to execute code to:
receive first environmental information for the information handling system;
set only a first application instantiated on the information handling system to an EcoQoS level based on the first environmental information;
receive second environmental information for the information handling system, and
set the first application and a second application instantiated on the information handling system to the EcoQoS level based on the second environmental information.
